(19) United States
(12) Patent Application Publication
(10) Pub. No.: US 2015/0301728 A1
(43) Pub. Date: Oct. 22, 2015

(54) DATA OUTPUT CONTROL APPARATUS AND DATA OUTPUT CONTROL METHOD

(71) Applicants: Kenta ONOZUKA, Tokyo (JP); Tomohiro SAKAI, Tokyo (JP); Yuji YAMAMOTO, Tokyo (JP); Akihide TAKAI, Tokyo (JP)

(72) Inventors: Kenta ONOZUKA, Tokyo (JP); Tomohiro SAKAI, Tokyo (JP); Yuji YAMAMOTO, Tokyo (JP); Akihide TAKAI, Tokyo (JP)

(73) Assignee: DWANGO CO., LTD., Tokyo (JP)

(21) Appl. No.: 13/383,686

(22) PCT Filed: Aug. 2, 2011
(86) PCT No.: PCT/JP2011/067658

§ 371 Date: May 11, 2012

(30) Foreign Application Priority Data
Aug. 3, 2010 (JP) 2010-174392

(51) Int. Cl. G06F 3/0484; G06F 3/0481; G06F 17/30

(52) U.S. Cl. CPC G06F 3/04847; G06F 17/3053; G06F 3/0481

(57) ABSTRACT

A data output control apparatus includes a memory unit storing a plurality of data being output and values respectively associated with the data, the plurality of data and the values being corresponded respectively, a display control unit displaying a slider bar on a display unit, the slider bar receiving selection of a specific value from a range of the corresponded values, an input unit receiving an input of a select value selected by the slider bar displayed on the display unit, and an output control unit reading data corresponding to the data input by the input unit from the memory unit, the data being corresponded to the select value selected by the slider bar.

### CROSS REFERENCE TO RELATED APPLICATIONS

Priority is claimed on Japanese Patent Application No. 2010-174392, filed Aug. 3, 2010, the content of which is incorporated herein by reference.

### BACKGROUND OF THE INVENTION

1. Field of the Invention

The present invention relates to a data output control apparatus and data output control method.

2. Description of Related Art

With respect to multiple data stored in a computer apparatus or the like, when specific data is selected and output to a display unit or a speaker, the computer apparatus such as a PC (Personal Computer) first displays a list of data (file) included in a specific folder on a display unit. Then, the computer apparatus outputs the data selected with a mouse, a keyboard or the like operated by a user from the list of data indicated on the display unit.

In another case, for example, when moving pictures are delivered with a web service and specific data is output from multiple data (moving picture) registered as “favorites” or the like by a user, a web server transmits the list of titles of registered moving pictures or the like to a user terminal unit and displays the title on the display unit. Further, the web server receives information indicating the data selected from the list of data by the user, and transmits the selected data to the user terminal unit.

For example, patent publication 1, Japanese Patent Publication 2007-531160, describes a search service which uses key words on the Internet, in which information displayed in the order of searched results can be modified in response to the user's interests.

With respect to multiple data output by a computer apparatus, when the number of data being a selective object is large, it may be difficult for a user to select desired data from the large number of data in some cases. For example, when specific data is selected from multiple data stored in a specific folder, it would be easy for a user to determine desired data when the number of data indicated in the data list is small. However, when the number of data list is large, such as a couple of tens to a couple of hundreds or a couple of thousands, it would be impossible for the user to recognize the whole data at a glance, so that the user cannot find the desired data. There is a data output control apparatus having a sorting function that sorts data based on, for example, the date of data or data types (e.g., type of extension). However, when several hundreds of data are sorted by date, several data having a recent date are indicated on the screen of a display monitor in the descending order at one time, and several data having an earlier date are indicated on the screen of a display monitor in the ascending order at one time. In this case it would be difficult to choose data having a midterm date from the several hundreds of data.

Similarly, for example, with respect to a web service distributing moving pictures, in a case where there are multiple data (moving pictures) chosen as “favorite pages” by a user, if the data exist from several tens to several hundreds or more, it would be difficult for the user to find specific data from them. In such a case, the provider of the web service might loose chances for delivering data to users.

One of the objects in accordance with the present invention is to provide a data output control apparatus and a data output control method, which make it possible to easily choose specific data from multiple data.

### SUMMARY OF THE INVENTION

The present invention has been made to achieve the objects described above by introducing the following.

In accordance with one embodiment of the present invention, a data output control apparatus may include a memory unit storing a plurality of data being output and values respectively associated with the data, the plurality of data and the values being corresponded respectively, a display control unit displaying a slider bar on a display unit, the slider bar receiving selection of a specific value from a range of the corresponded values, an input unit receiving an input of a select value selected by the slider bar displayed on the display unit, and an output control unit reading data corresponding to the data input by the input unit from the memory unit, the data being corresponded to the select value selected by the slider bar.

In accordance with another embodiment of the present invention, a memory unit of a data output control apparatus may store different types of scores respectively associated with the plurality of data. The display control unit displays multiple slider bars on the display unit, the multiple slider bars are respectively corresponded to the different types of scores corresponded to the plurality of data, and the output control unit reads out the data corresponding to the selected plural values selected with the plurality of slider bars from the memory unit and outputs the data on the output unit.

In accordance with another embodiment of the present invention of a data output control apparatus, a display control unit may display an amount of data in response to the select value selected by the slider bar based on a predetermined display method.

In accordance with another embodiment of the present invention of a data output control apparatus, the amount of data in response to the select value selected by the slider bar may be displayed based on the variation of colors on the display unit.

In accordance with another embodiment of the present invention, a data output control method may include storing a plurality of data being output and values respectively associated with the data, the plurality of data and the values being corresponded respectively, displaying a slider bar on a display unit, the slider bar receiving selection of a specific value from a range of the corresponded values, receiving an input of a select value selected by the slider bar displayed on the display unit, and reading data corresponding to the data input by the input unit from the memory unit, the data being corresponded to the select value selected by the slider bar.

As described above, according to the present invention, a memory unit stores multiple data being output and values being respectively associated with and corresponded to each other, a display unit displays a slider bar receiving the selection of a specific value from the range of the values corresponding to the multiple data, an input unit receives the select value by use of the slider bar displayed on the display unit, and an output unit reads out and outputs the data corresponding to the value having been input by the input unit. Thus, a data output control apparatus and a data output control method are provided which can easily choose specific data from multiple data.

### BRIEF DESCRIPTION OF THE DRAWINGS

FIG. 1 is a block diagram that illustrates a configuration of a data output control apparatus in accordance with a first embodiment of the present invention;

FIG. 2 is a drawing that illustrates data stored in a memory unit in accordance with the first embodiment of the present invention;

FIG. 3 is a drawing that illustrates a screen displayed in a display unit in accordance with the first embodiment of the present invention;

FIG. 4 is a drawing that illustrates the screen displayed on the display unit in accordance with the first embodiment of the present invention;

FIG. 5 is a flowchart that illustrates the operation of the data output control apparatus in accordance with the first embodiment of the present invention;

FIG. 6 is a drawing that illustrates an example of a slider bar in accordance with a second embodiment of the present invention;

FIG. 7 is a drawing that illustrates another example of the slider bar in accordance with a third embodiment of the present invention;

FIG. 8 is a drawing that illustrates data stored in a memory unit in accordance with the third embodiment of the present invention;

FIG. 9 is a drawing that illustrates the screen indicated in a display unit in accordance with the third embodiment of the present invention;

FIG. 10 is a block diagram that illustrates the configuration of a moving picture delivering system in accordance with a fourth embodiment of the present invention;

FIG. 11 is a flowchart that illustrates an example of the operation of a data output control apparatus in accordance with the fourth embodiment of the present invention; and

FIG. 12 is a flowchart that illustrates another example of the operation of the data output control apparatus in accordance with the fourth embodiment of the present invention.

### DETAILED DESCRIPTION OF THE INVENTION

With reference to the figures, a description will be given below of a first embodiment in accordance with the present invention.

### First Embodiment

FIG. 1 is a block diagram that illustrates a configuration of a data output control apparatus 10 in accordance with a first embodiment of the present invention. The data output control apparatus 10 includes a memory unit 11, an input unit 12, a display unit 13, a display control unit 14, an output unit 15, and an output control apparatus 16.

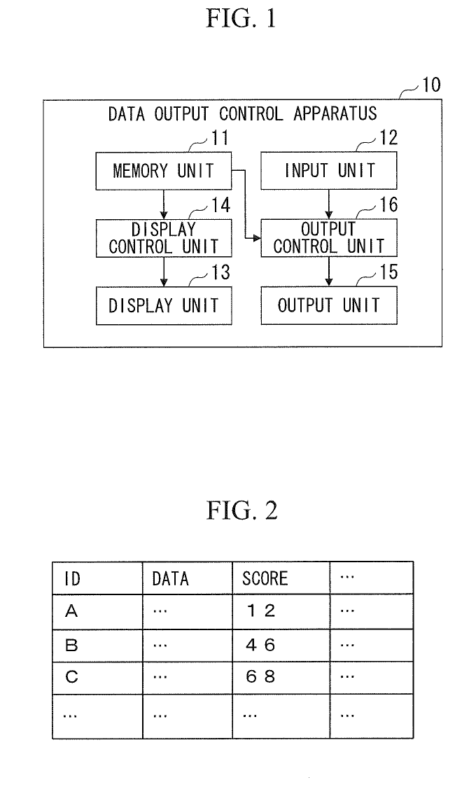

The memory unit 11 stores identification information (ID) that identifies each of multiple data to be output, content of each data, and a numerical value (score) associated with each of the multiple data by associating each of them. FIG. 2 is a drawing that illustrates data stored in the memory unit 11 in accordance with the first embodiment of the present invention. In this case, the data to be output may be data associated with its score. For example, the data to be output may be a document file or the like stored in a folder of a PC (Personal Computer), or moving picture data to be delivered by a moving picture delivering service. Further, the data to be output may be voice data, web page data, profile data or image data. The score may be information that indicates a preference corresponding to the data. For example, the score may be an evaluation value determined with respect to the data of the score, date, data size, a number linked to a webpage, a number of bookmarks or the like. In another case, the score may be a value which indicates that the data is for either male or female, or a value indicating age.

The input unit 12 is an input device that receives an operation input from a user. For example, a keyboard or mouse is applicable. According to the first embodiment, the input unit 12 receives a score (number) input chosen with a slider bar displayed on the display unit 13 controlled by the display control unit 14.

The display unit 13 is a display unit that displays a screen in response to the operation input by the user.

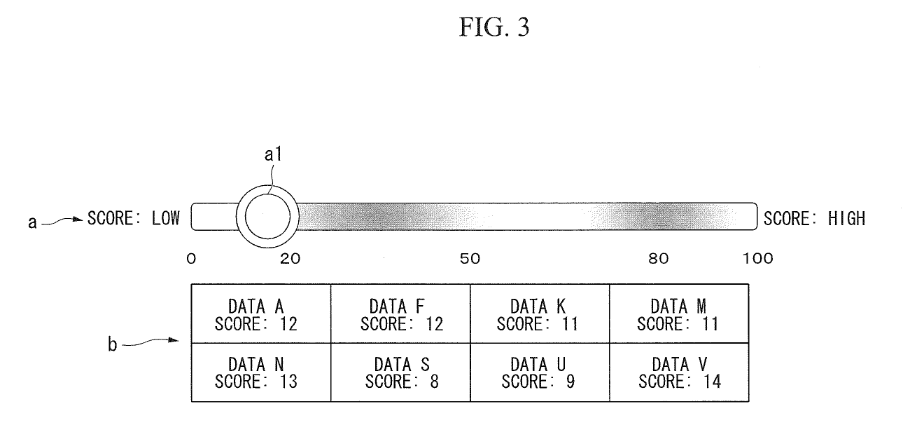

The display control unit 14 generates a slider bar which receives a choice of a specific score within a range of scores corresponding to multiple data stored in the memory unit 11, and indicates them on the display unit 13. FIG. 3 is a drawing that illustrates an example of the screen displayed on the display unit 13 controlled by the display control unit 14. A symbol a indicates a slider bar, and a symbol b indicates data read by the output control unit 16 in response to the score chosen by the slide bar a. In this case, the display control unit 14 displays the amount of data on the display unit 13 in response to the score chosen by the slider bar a based on a predetermined display method.

FIG. 3 shows an example where the display control unit 14 displays the amount of data in response to the score chosen by use of the slider on the display unit 13 based on variations of colors. For example, the display control unit 14 shows different colors for each of a data section having the amount of data being 0 and a data section having the amount of data being equal or more than 1. Specifically, for example, the display control unit 14 shows as white for the data section having the amount of data being 0, and shows as red for the data section having the amount of data being equal or more than 1. Further, when the amount of data is equal or more than 1, the display control unit 14 can display a deeper color for a data section where the amount of data is large, and display a lighter color for a data section where the amount of data is less.

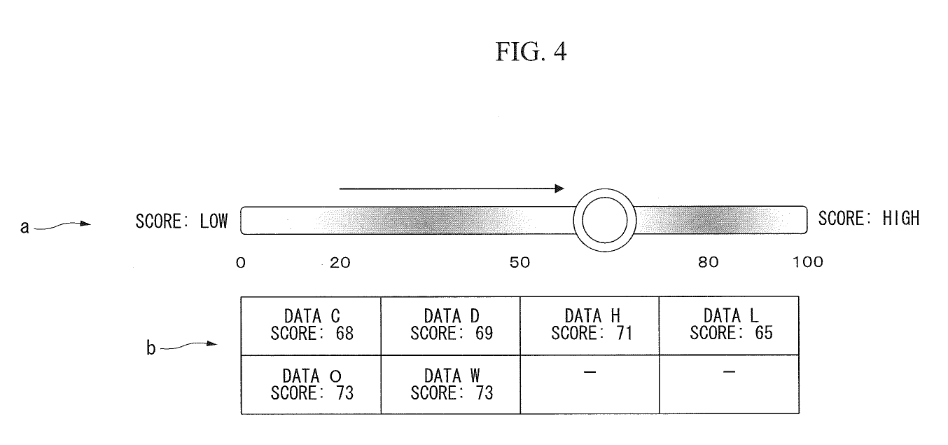

In FIG. 3, the slider bar shows a deeper color for a score where the amount of data is large, a light color for a score where the amount of data is less, and further, shows no color or a slight color for a score where there is little amount of data. Namely, when the score is roughly between 0 and 20, the slider bar shows no color or a light color, when the score is roughly between 20 and 50, the slide bar shows a deep color, and when the score is roughly between 50 and 70, the slider bar shows no color or a light color. When the score is roughly more than 80, the slider bar shows a deep color, and when the score is roughly between 90 and 100, the slider bar shows no color or a light color. According to this, the user can see the distribution of scores corresponding to the data. With respect to a usual method where data in a folder is listed, data can be sorted based on their attributes (score) such as date. However, for understanding the distribution or deviation of data, procedures such as a multiple data search or multiple data sorting are necessary for taking a statistical approach. On the other hand, in accordance with the first embodiment, the amount of data is expressed as color variations of the slider bar, so that the data distribution or data deviations can be expressed in a visually understandable form based on the slider bar. According to this, it is easy for a user to confirm sections where data exists and sections where no data exists by use of the slider bar. In addition, for example, if no data exists for a whole section on the slider bar, the existence of no data can be clearly indicated. FIG. 4 is a drawing that illustrates an example where the slider (knob indicated by a symbol al) of the slider bar has been slid in response to the operation input of the input unit 12. In this case, the data indicated as the symbol b has been modified by the output control unit 16, which will be described below.

When such a slider bar is applied to a stand-alone system, for example, the slider bar may be generated by an executable file of a client terminal. Also, when the slider bar is used in a web service, the slider bar may be generated by a client-side program, or may be generated by a server-side program. Furthermore, the slider bar may be generated by cooperation between the client-side program and the server-side program.

For example, the display control unit 14 can calculate each amount of data corresponding to one of score values. The display control unit 14 calculates a ratio of each amount of data for another amount of data. The display control unit 14 can assign each of the score values to a color value indicating a color.

The output unit 15 outputs data read out by the output control unit 16. For example, the output unit 15 may be any display devices such as a display unit when the data is formed by a document or image data. Also, the output unit 15 may be a sound generation device such as a speaker unit when the data is voice data. When the data is the contents of moving pictures including sound, the output unit 15 may include both of the display device and the speaker unit. When the output unit 15 is the display unit, the functional parts of the display unit 13 and the output unit 15 may be the same.

The output control unit 16 reads out data corresponding to the score input from the input unit 12 from the memory unit 11 and outputs the data to the output unit 15. For example, as indicated by the symbol a in FIG. 3, when the score “12” is chosen, the output control unit 16 reads out the data of the score “12” from the memory unit 11, and outputs the data to the location indicated by the symbol b. When data to be output corresponds to an image or a letter, the output unit 15 may output the data to the location of the symbol b. In the first embodiment, an example shows that an ID of data is read from the memory unit 11 and displayed on the screen. The information (ID) output at the location of the symbol b may be a file name or a thumbnail image of image data, for example. The output unit 16 sets up a link for opening actual data to the ID of data displayed at the location of the symbol b, and outputs the actual data when the link is clicked on. In this case, plural data are stored in the memory unit 11. When the number of data is too much for a user to identify the whole data at once, the data can be displayed and output by classifying based on each selected score. Thereby, the user can easily choose the specific data from plural data and identify the data efficiently.

In this way, the output unit 15 may output the whole data corresponding to the score selected by the slider bar. Further, the number of data to be displayed by the output unit 15 at once may be a predetermined value (for example, eight data). When the number of data is less than the predetermined value, data corresponding to a predetermined range of scores (e.g., score ranges in ±5) may be output. On the other hand, when the number of data is more than the predetermined value, the output unit 15 may choose data output by another factor, or choose data at random. In this way, when the slider bar is shifted as indicated by the symbol a of FIG. 4, and when a score “68,” for example, is chosen, the output control unit 16 reads out and outputs the data corresponding to “68.”

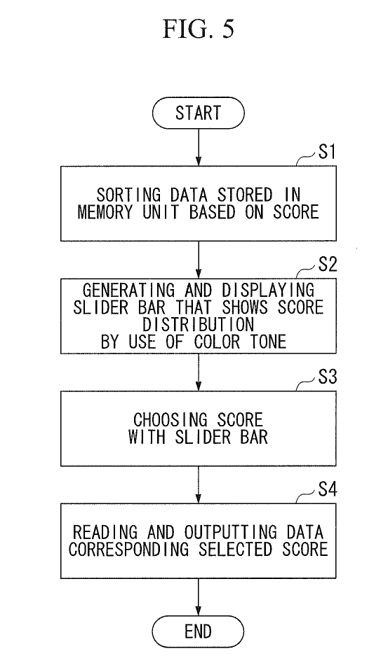

Furthermore, a description will be given of the data output control apparatus 10 in accordance with the first embodiment. FIG. 5 is a flowchart that illustrates the operations of data output of the data output control apparatus 10 in response to an input of the slider bar.

The display control unit 14 of the data output control apparatus 10 sorts data stored in the memory unit 11 based on the score corresponding to the data (step S1). The display control unit 14 generates a slider bar which expresses the distribution of scores corresponding to the data based on variations of colors, and shows a screen displaying the generated slider bar on the display unit 13 (step S2). Further, the input unit 12 receives the score selected and input by the user in response to the screen displayed on the display unit 13 (step S3). The output control unit 16 reads out the data corresponding to the score input by the input unit 12 from the memory unit 11, and makes the output unit 15 output the data (step S4).

### Second Embodiment

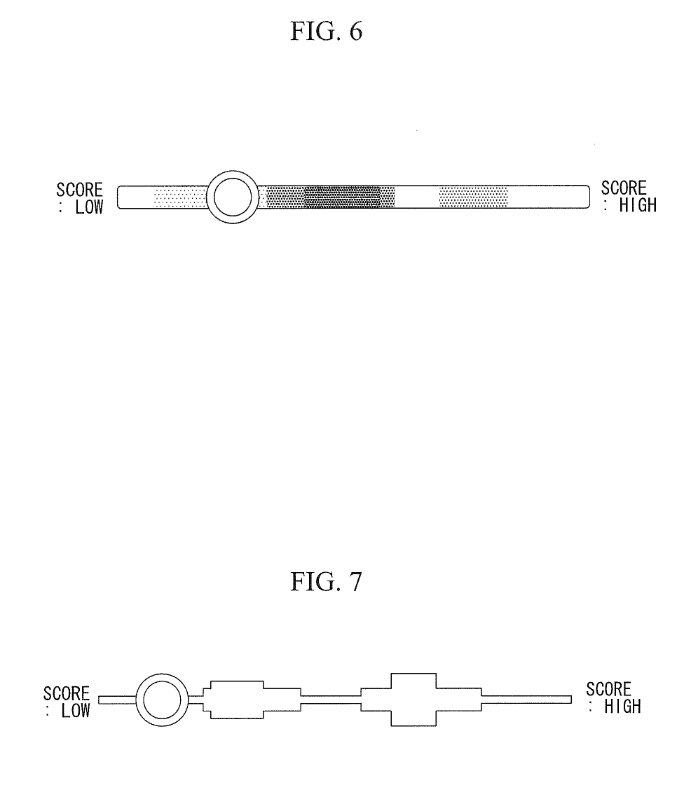

A description will be given of the second embodiment in accordance with the present invention. Although, in the first embodiment, an example is described in which the display control unit 14 generates the slider bar that expresses the distribution of scores based on the variation of colors, the slider bar expressing the amount of data may be generated by another indication method. For example, the display control unit 14 may be configured to generate a slider bar that indicates the amount of data based on the color tone. The display unit 14, as shown in FIG. 6, may be configured to generate a slider bar expressing the amount of data based on the density of dots. Furthermore, the display control unit 14, as shown in FIG. 7, may be configured to generate a slider bar expressing the amount of data based on the thickness of the bar.

### Third Embodiment

A description will be given of the third embodiment. In the first embodiment, although an example is shown that illustrates the memory unit 11 storing data each of which is corresponded to a single score, the memory unit 11 may be configured to store multiple data each of which is associated with and corresponded to multiple types of scores (values). In this case, the display control unit 14 shows multiple slider bars corresponded to each of the multiple types of scores on the display unit 13. In addition, the output control unit 16 reads out data corresponding to the multiple scores chosen by the multiple slider bars from the memory unit 11 and outputs the data to the output unit 15.

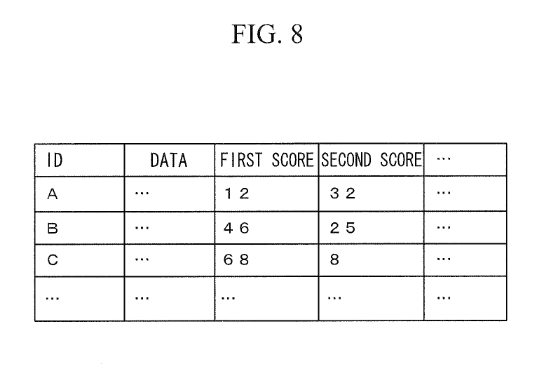

FIG. 8 is a drawing that illustrates an example of data stored into the memory unit 11 of the data output control apparatus 10 in accordance with the third embodiment. Each of the data is stored into the memory unit 11 by corresponding to different types of scores such as a first score and a second score.

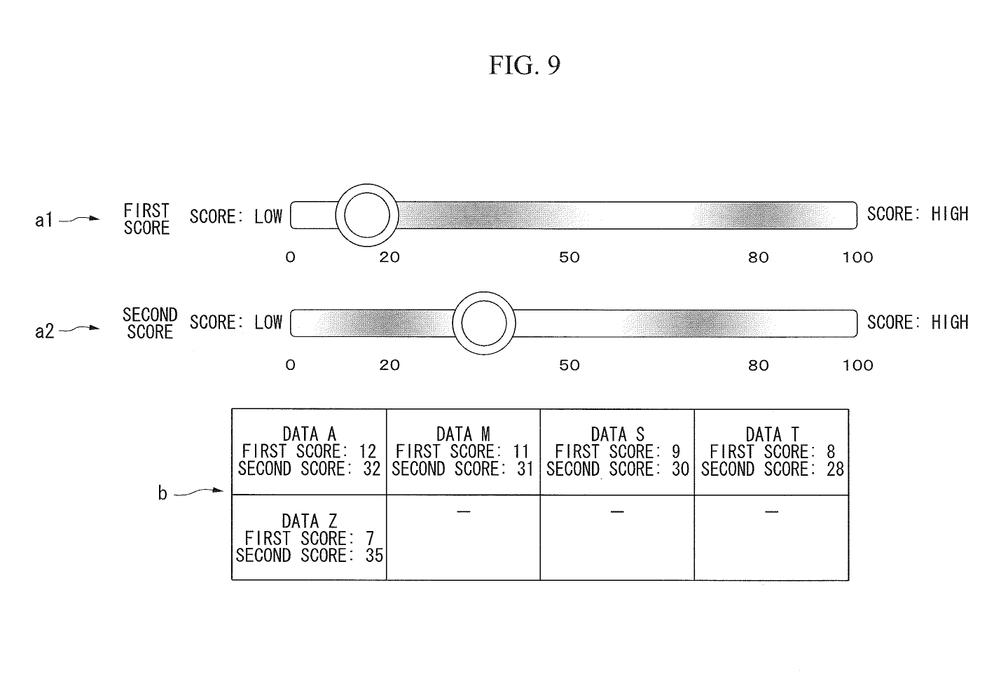

FIG. 9 is a drawing that illustrates an example of a screen displayed on the display unit 13 (output unit 15) in accordance with the third embodiment of the present invention.

The display control unit 14 generates a slider bar (indicated by symbol a1) corresponding to the first score and another slider bar (indicated by symbol a2) corresponding to the second score, and displays them on the display unit 13. The output control unit 16 reads out data corresponding to the multiple scores chosen by the multiple slider bars from the memory 11 and displays them on the output unit 15 as shown as a symbol b. In this case, the output control unit 16 may be capable of selecting “AND” condition, “OR” condition or either “AND” condition or “OR” condition for displaying the multiple scores selected by the multiple slider bars. Up to now, although it is shown that the example illustrates that each of data is corresponded to two types of scores, three or more than three types of scores may be corresponded to each of the data. In another case, when displaying data corresponded to the multiple types of scores, for example, it is possible for the display control unit 14 to display the data by use of a three-dimensional axis instead of the slider bars.

### Fourth Embodiment

A description will be given of the fourth embodiment in accordance with the present invention. In this case, the moving picture delivering system 1 delivers contents such as moving pictures to multiple user terminals (user terminal 30-1, user terminal 30-2, . . . , user terminal 30-N: N>0, being an arbitrary natural number). Further, the moving picture delivering system 1 is capable of communicating among the multiple user terminals by sharing comments transmitted from the user terminals 30-N in response to the delivered contents.

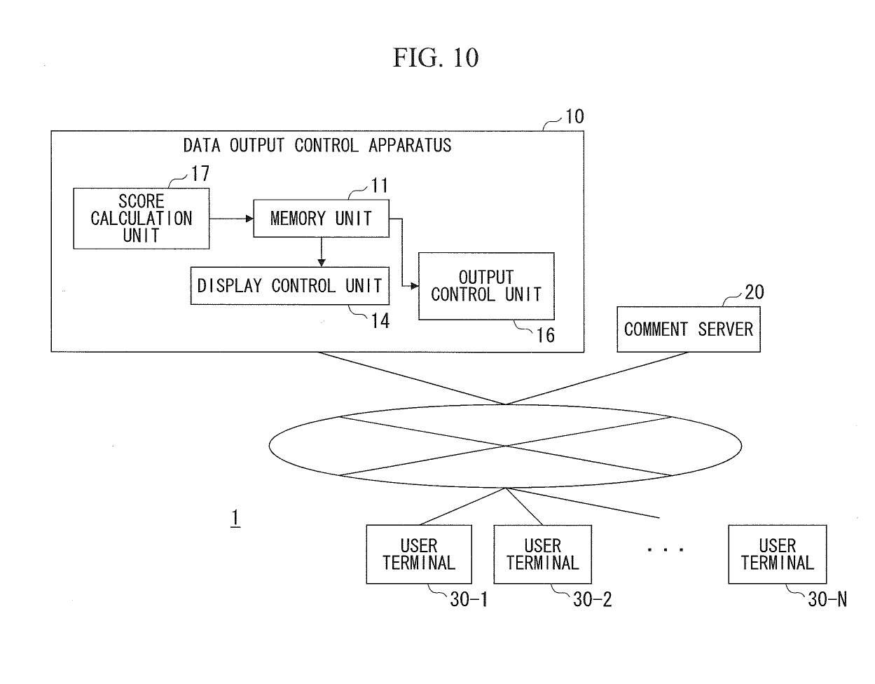

FIG. 10 is a drawing that illustrates the moving picture delivering system 1 having the data output control apparatus 10 in accordance with the fourth embodiment. The moving picture delivering system 1 includes the data output control apparatus 10, a comment server 20, and the multiple user terminals (user terminal 30-1, user terminal 30-2, . . . , user terminal 30-N: N>0, being an arbitrary natural number).

Although the data output control apparatus 10 includes the configuration identical to that of the first embodiment, the input unit 12, the display unit 13 and the output unit 15 do not need to be included, because the operation input, data indication and data output are performed by the user terminal 30-N. Further, the data output control apparatus 10 includes a score calculation unit 17 that calculates the scores of content data in response to the number of comments given to contents or the like. The memory unit 11 of the data output control apparatus 10 stores the contents to be delivered to the user terminal 30-N as data. The display control unit 14 transmits a generated display screen to the user terminal 30-N via the network. The output control unit 16 delivers the contents chosen by the user terminal 30-N to the user terminal 30-N via the network.

The comment server 20 receives a comment input to the user terminal 30-N in response to a content being delivered to the user terminal 30-N via the network, and stores the comment by corresponding with an ID (identification) or the like that identifies the content.

The user terminal 30-N displays the content delivered from the data output control apparatus 10 and the comment delivered from the comment server 20 on its own display unit. Further, the user terminal 30-N receives operation input by a user.

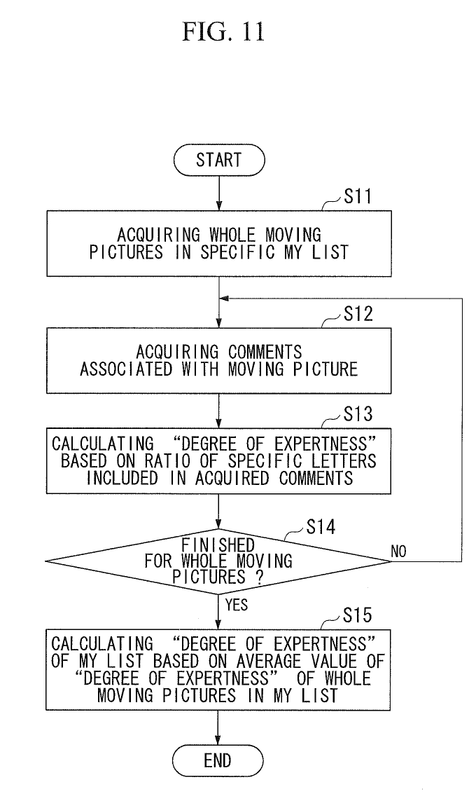

Next, a description will be given of the operations of the data output control apparatus 10 in accordance with the fourth embodiment. FIG. 11 is a flowchart that illustrates the operations which the data output control apparatus 10 calculates the scores corresponding to contents.

In this case, it is supposed that plural contents registered as “Favorites” or the like are stored into the memory unit 11 as “My list.” “My list” is a function that preliminarily registers and stores contents appointed by a user into the memory unit 11. Such a “My list” may be opened to other users and become subjects to be searched in the network. Further, the score calculation unit 17 calculates the “degree of expertness” of a content as a score based on a comment given to the content registered in “My list.” In this case, for example, the degree of expertness is a numerical value which indicates whether the degree of a content is for general users (light users) or expert users (heavy users) in the moving picture delivery system 1.

The score calculation unit 17 acquires a content registered as “My list” from contents stored in the memory unit 11 (step S11). Further, the score calculation unit 17 acquires the comment corresponding to the acquired content from the comment server 20 (step S12). The score calculation unit 17 detects specific letters included in the acquired comment, such as an emoticon of the ending of word or “w” indicating expansion of the ending of word. The score calculation unit 17 calculates the degree of expertness based on a ratio of the detected specific letters to the whole acquired comments, and stores the calculated degree of expertness corresponding to the content into the memory unit 11 (step S13).

Further, the score calculation unit 17 determines whether or not the calculation process of degree of expertness has been completed for the whole contents acquired in step S11 (step S14). When the score calculation unit 17 determines that the calculation process of degree of expertness has not been completed for the whole contents (step S14: NO), the operation step returns to step S12 and performs the calculation process of degree of expertness equally for the rest of contents having not been subjected to the calculation process. When the score calculation unit 17 determines that the calculation process of degree of expertness has been completed for the whole contents (step S14: YES), the score calculation unit 17 calculates a degree of expertness of “My list” based on the average value of the degree of expertness of the whole contents in “My list” (step S15).

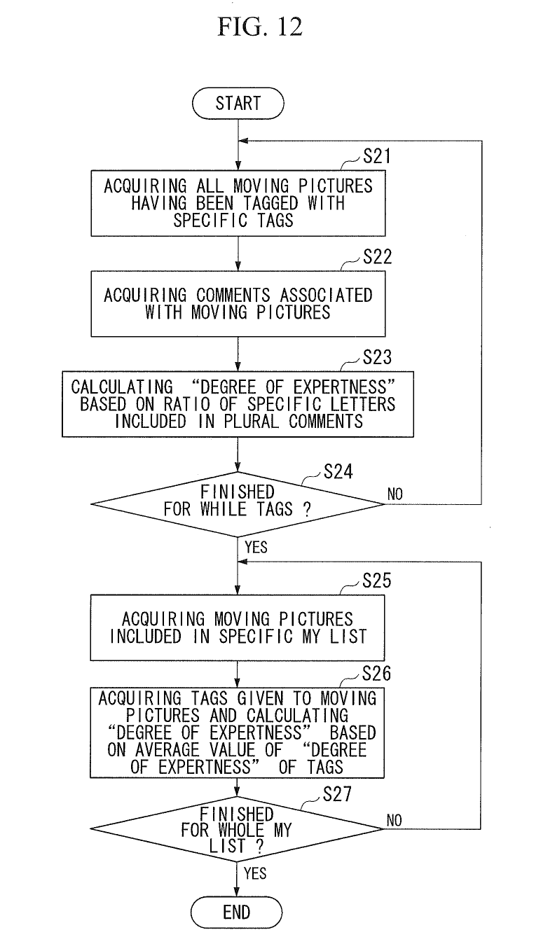

FIG. 12 is a flowchart that illustrates another operation which the data output control apparatus 10 calculates scores. In this case, the content stored in the memory unit 11 is given a tag that is meta data indicating the content itself or the like. The tag may be optionally set by a user, or the provider of the moving picture delivery system 1. The score calculation unit 17 acquires contents having a tag from the contents stored in the memory unit 11. (step S21). The score calculation unit 17 acquires multiple latest comments (e.g., 50 comments), which are associated with contents, from the comment server 20 (step S22). Further, the score calculation unit 17 detects specific letters included in the acquired comments and calculates the degree of expertness based on a ratio of the detected specific letters to the whole acquired comments (step S23).

Further, the score calculation unit 17 determines whether or not the calculation process of the degree of expertness has been performed for the whole determined tags (step S24). When the score calculation unit 17 determines that the calculation process of the degree of expertness has not been performed for the whole determined tags (step S24: NO), the operation step returns to step S21, and the calculation process of the degree of expertness is performed equally for the rest of other tags. When the score calculation unit 17 determines that the calculation process of the degree of expertness has been performed for the whole tags (step S24: YES), the score calculation unit 17 acquires contents included in specific “My lists” (step S25). The score calculation unit 17 acquires the tags given to the contents, calculates an average of degree of expertness of the tags and stores the average of degree of expertness into the memory unit 11 associating with the contents (step S26). The score calculation unit 17 determines whether or not the calculation process of degree of expertness has been completed for the whole “My list”s (step S27). When the score calculation unit 17 determines that the calculation process of degree of expertness has not been completed for the whole “My lists” (step S27: NO), the operation process returns to step S25 and the calculation process of degree of expertness is performed equally for the rest of other “My lists” on which the calculation process of degree of expertness has not been performed. When the score calculation unit 17 determines that the calculation process of degree of expertness has been performed for the whole “My lists” (step S27: YES), the calculation unit 17 stops the calculation process. Further, when the present embodiment of the invention is applied to the moving picture delivering system, the scores corresponded to the contents may be determined based on the number of comments, a degree of recommendation or the like.

Furthermore, a program realizing the functions of the operation unit in accordance with the present invention may be recorded into a computer-readable recording medium, and the data output control may be performed by making a computer system readout the program recorded into the recording medium. In this case, the “computer system” is a system including the operation system (OS) and hardware such as peripheral apparatuses. Further, the “computer system” may include a WWW system having a home page providing environment (or display environment). Furthermore, the “computer-readable recording medium” may include a portable medium such as a flexible disk, a magneto-optical disk, an ROM, a CD-ROM, and a storage device such as a hard drive included in the computer system. The “computer-readable recording medium” may include a nonvolatile memory (RAM) included in a computer system used for a server or a client machine, to which the program is transmitted via a network such as the Internet or communication lines such as telephone lines and temporally stores the program.

Further, the above program may be transmitted from a computer system storing the program in a storage device of the computer system or the like to another computer system via a transmission medium or a transmission wave in the transmission medium. In this case, the “transmission medium”, which transmits the program, may be a medium that includes functions of transmitting information, which is a network (communication network) such as the Internet or communication lines (communication line) such as telephone lines. Further, the above program may be a program that realizes part of the functions above. Furthermore, the program may be differential files (differential programs) which can realize the above functions by combination with the programs having already been stored in the computer system.

The above embodiments can be applied to a data output control apparatus and a data output control method, which are capable of easily choosing specific data from multiple data.

### DESCRIPTIONS OF SYMBOLS

1 MOVING PICTURE DELIVERING SYSTEM
10 DATA OUTPUT CONTROL APPARATUS
11 MEMORY UNIT
12 INPUT UNIT
13 DISPLAY UNIT
14 DISPLAY CONTROL UNIT
15 OUTPUT UNIT
16 OUTPUT CONTROL APPARATUS
17 SCORE CALCULATION UNIT
20 COMMENT SERVER
30 USER TERMINAL

What is claimed is:

1. A data output control apparatus, comprising:
a memory unit storing a plurality of data being output and values respectively associated with the data, the plurality of data and the values being corresponded respectively;
a display control unit displaying a slider bar on a display unit, the slider bar receiving selection of a specific value from a range of the corresponded values;
an input unit receiving an input of a select value selected by the slider bar displayed on the display unit; and
an output control unit reading data corresponding to the data input by the input unit from the memory unit, the data being corresponded to the select value selected by the slider bar.

2. The data output control apparatus according to claim 1, wherein:
the memory unit stores different types of scores respectively associated with the plurality of data;
the display control unit displays multiple slider bars on the display unit, and the multiple slider bars are respectively corresponded to the different types of scores corresponded to the plurality of data; and
the output control unit reads out the data corresponding to the selected plural values selected with the plurality of slider bars from the memory unit and outputs the data on the output unit.

3. The data output control apparatus according to claim 1, wherein the display control unit displays an amount of data in response to the select value selected by the slider bar based on a predetermined display method.

4. The data output control apparatus according to claim 3, wherein the amount of data in response to the select value selected by the slider bar is displayed based on the variation of colors on the display unit.

5. A data output control method, comprising:
storing a plurality of data being output and values respectively associated with the data, the plurality of data and the values being corresponded respectively;
displaying a slider bar on a display unit, the slider bar receiving selection of a specific value from a range of the corresponded values;
receiving an input of a select value selected by the slider bar displayed on the display unit; and
reading data corresponding to the data input by the input unit from the memory unit, the data being corresponded to the select value selected by the slider bar.
